(19) United States
(12) Patent Application Publication
(10) Pub. No.: US 2009/0071349 A1
(43) Pub. Date: Mar. 19, 2009

(54) Tipping and tailing machine for vegetables

(76) Inventors: Brian Everett, Hockwold (GB); Bernard Everett, Watton (GB)

Correspondence Address: O'KEEFE, EGAN, PETERMAN & ENDERS LLP, 1101 CAPITAL OF TEXAS HIGHWAY SOUTH, #C200, AUSTIN, TX, 78746, US

(21) Appl. No.: 12/283,715

(22) Filed: Sep. 15, 2008

(30) Foreign Application Priority Data
Sep. 18, 2007 (GB) GB0718232.2

(51) Int. Cl. A23N 15/00; A23N 15/04

(52) U.S. Cl. 99/636; 99/643

(57) ABSTRACT

Vegetables, especially carrots, have both ends trimmed by this machine. The machine has an inclined table which forms a track and product guides in the form of troughs are attached to a belt so that the guides travel around the table when the belt is driven around the track. The guides are arranged with their long dimensions extending radially as they travel around the track. Carrots are fed into the trough-like guides at the upper side of the track and slide down the guides until they reach a stationary fence. The guides than travel past a blade which cuts off one end. As the guides continue to travel around the track, they change orientation so that the end of each guide which was at the top is then at the bottom, and the carrot slides to the other end of the guide before passing a second blade where the opposite end is cut off. The second blade may be one or a number of parallel blades so that the carrot can be cut into segments of desired length before those segments fall out of the machine at into a collection chamber.

This application claims priority to co-pending United Kingdom patent application serial number 0718232.2 filed on Sep. 18, 2007, which is entitled “Tipping And Tailing Machine For Vegetables” the disclosure of which is incorporated herein by reference.

This invention relates to a machine for tipping and tailing vegetables. The machine is particularly designed for tipping and tailing carrots, but could also be used for tipping and tailing other vegetables. Although the invention is not restricted to use with carrots, it will be described in this specification with particular reference to carrots.

Carrots are a very versatile vegetable. As well as being sold “as grown”, there is a demand for carrot pieces cut to specific sizes, and for machines to cut carrots into specific sizes. In mechanised vegetable treatment machines, the vegetables are fed into the machine from a hopper. In respect of carrots and other elongate vegetables, the carrots can be lined up as they pass into the machine, but it is difficult to align them mechanically so that they are either “top first” or “tail first”.

The invention provides a machine which will reliably both top and tail carrots, irrespective of the orientation in which they are introduced into the machine.

According to the present invention, there is provided a machine for tipping and tailing elongate products, the machine comprising a continuous belt running around a track, the track lying in a plane which is inclined to the horizontal, the belt carrying elongate product guides attached to the belt and each arranged with their long axes extending radially relative to the belt and lying in the plane of the track, means for driving the belt in rotation around the track, a first blade arranged at the lower end of an upper run of the belt, and a second blade arranged at the lower end of a lower run of the belt.

The track is preferably oval with the belt running around two pulleys, the pulleys also lying in the plane of the track

The belt may be made from any material. Preferably the belt is in the form of a chain which can be engaged with drive sprockets, but it may be possible to use other type of belts, for example a toothed rubber belt.

The guides and the angle of inclination (which is preferably between 40° and 50°, ideally 45°) are arranged so that the carrots will always slide to the lower end of the guide. When a carrot is introduced to a guide on the upper run, it will slide down the guide until one end lies against a fence at the lower end of the guide. The belt will then advance the guide so that the carrot passes the position of the first blade, where an end of the carrot will be cut off. The belt than drives the guide around one of the pulleys which results in the what was the lower end of the guide becoming the upper end. The carrot will then slide down the guide under the influence of gravity (and possible centrifugal force) so that the uncut end is at the (new) bottom of the guide, and that end will then be cut off.

The blades are preferably continuously rotating cut-off discs.

The track can include low-friction bearers and the product guides slide on those bearers as the guides move around the track. The whole length of the belt is occupied by product guides, so that a continuous stream of carrots or other products arriving at the machine will always fall into one or other of the guides. There may be a number of second blades arranged at the lower end of the lower run of the belt. All these blades can be parallel to one another and spaced apart by a distance equal to the desired segment size into which the product is to be cut. The product guides can be provided with slots aligned with the positions of the blades.

Fences are preferably provided at the lower ends of the product guides at those places where the guides will, in use, contain products.

The machine is primarily intended for tipping and tailing carrots, but can find other uses.

The invention will now be further described, by way of example, with reference to the accompanying drawings, in which:

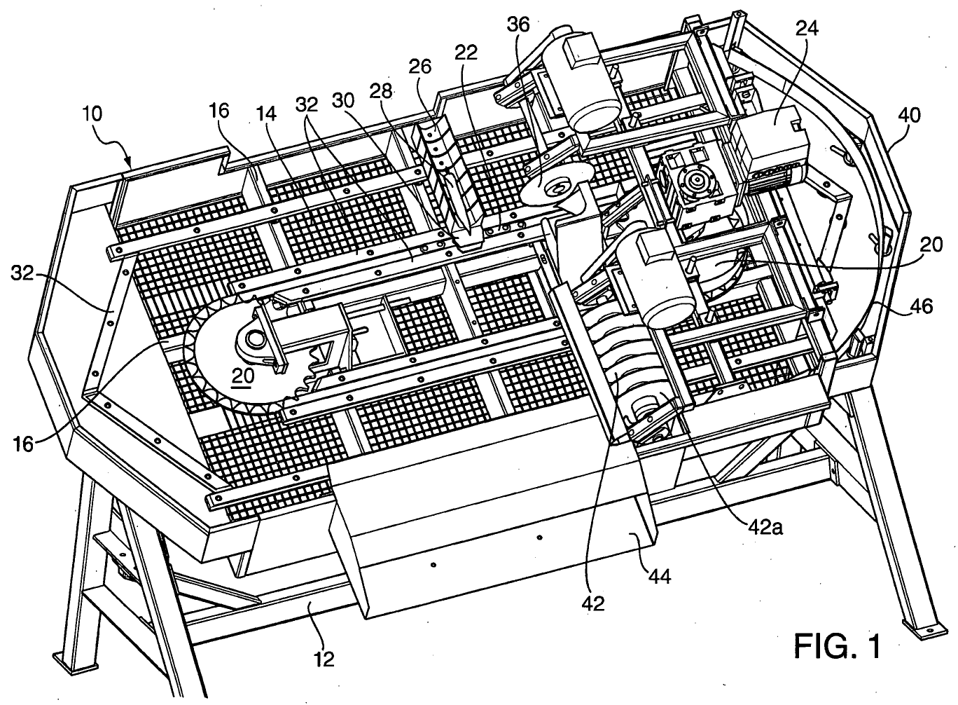

FIG. 1 is a perspective view of a machine in accordance with the invention with all but one of the product guides removed;

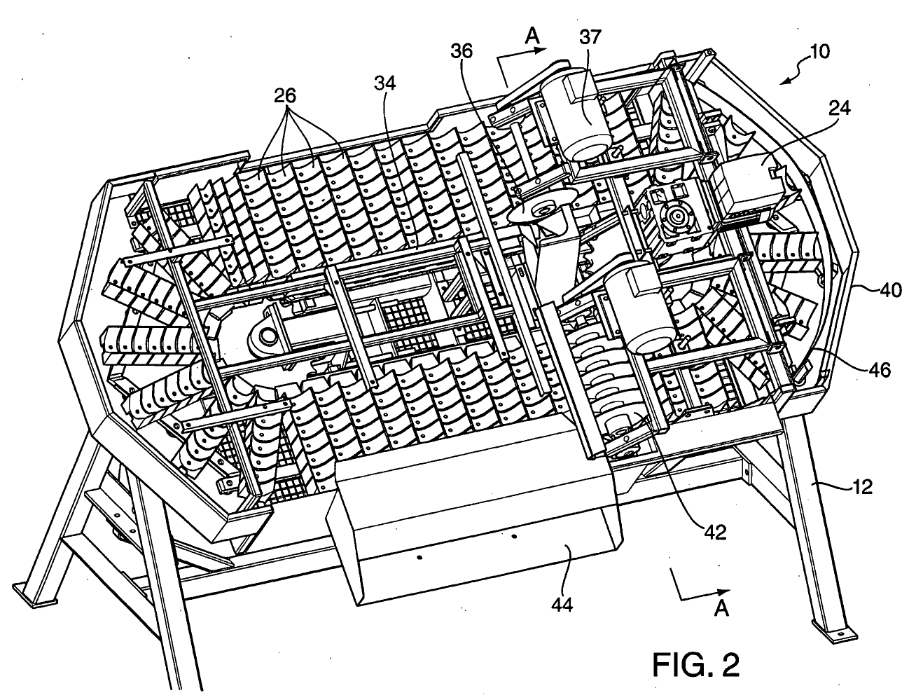

FIG. 2 is a view corresponding to FIG. 1, with a full population of product guides;

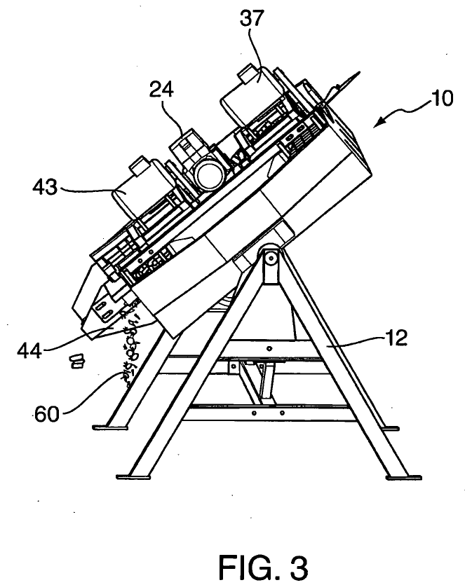

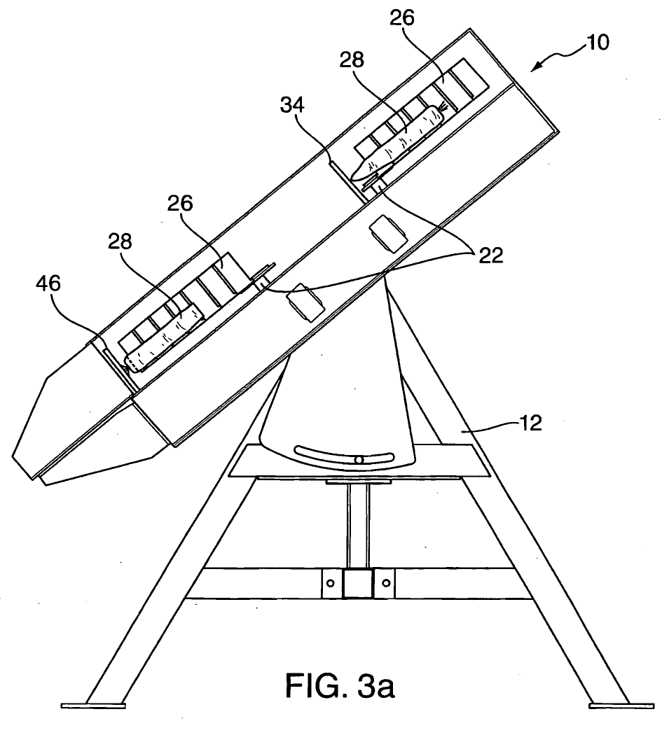

FIG. 3 is an end view of the machine of FIGS. 1 and 2;

FIG. 3a is a schematic section on the line A-A through the machine of FIG. 2, with the blades and other components omitted;

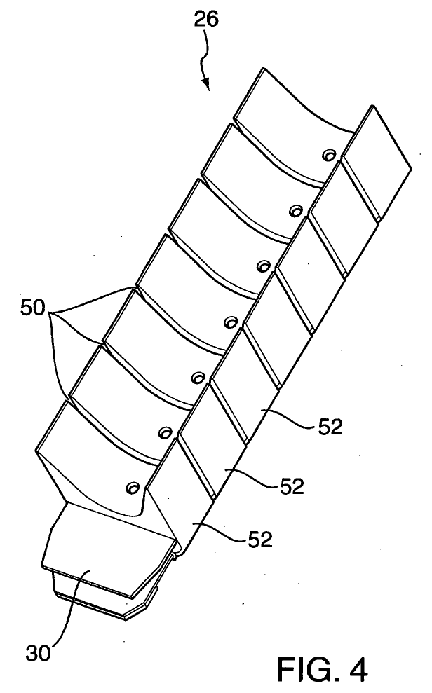

FIG. 4 is a perspective view of a single product guide; and

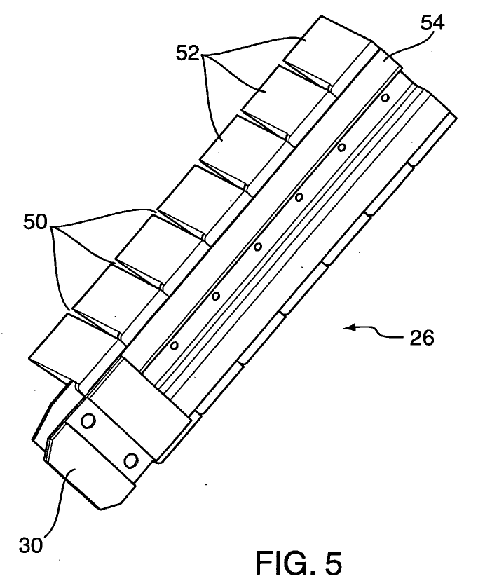

FIG. 5 is a view from underneath of the guide of FIG. 4.

The machine shown in the figures has a table 10 mounted on a stand 12. As can be seen in FIG. 3, the table 10 is set at an angle to the horizontal, preferably 45°. The table has an open base covered by a wire mesh 14, and a framework 16 which supports a drive assembly in the centre of the table. The drive assembly comprises two toothed sprockets wheels 20, and a chain 22 runs around these sprocket wheels. In FIG. 1, only a short section of the chain 22 is shown, but it will be understood that the chain will extend in a continuous loop around both the wheels 20.

The right-hand wheel 20 is driven by a motor 24.

Mounted on the chain 22 are a series of trough-like product guides 26. In FIG. 1 only one of these guides 26 is shown, and a representative carrot 28 is shown in this guide. The inner end 30 of the guide is fixed to the chain 22, so that as the chain rotates, the guide 26 travels around the path of the chain. The guide rests on slide bearers 32, so that the guides can travel around the table with minimum friction. Because of the slant of the table, the carrot 28 in the guide 26 will slide down the guide until its tip rests against a fence 34 (see FIG. 2) which is spaced a short distance from the end of the guide.

As the motor 24 drives the chain 22, the guide 26 will be advanced in a clockwise direction towards a rotating blade 36. The blade 36 is driven by a motor 37 and the position of the blade will be set between the lower end of the guide 26 and the fence 34, so that when the carrot arrives at the blade, the blade will cut off the end of the carrot which was resting against the fence and projecting beyond the end of the guide. The cut end will drop through the table into a suitable collection chamber, and the guide 26 will continue on its path around the table.

Because the guide is attached to the chain only at its inboard end, the guide will move from the vertical, through the horizontal and back to the vertical, as it passes around the end 40 of the table. The end of the guide which was uppermost then becomes lowermost. This can be seen in FIG. 2. Once the guide has passed through the horizontal position and moves on towards a vertical position, gravity will result in the carrot sliding along the guide to the other end of the guide where there is a second fence 46. FIG. 3a illustrates schematically the arrangement of the guides 26 and the fences 34 and 46 and the gap between the lower ends of the guides and the respective fences.

Then in the bottom run of the track, the carrot will encounter a set of blades 42, and the bottom most of these blades 42a will cut off the end of the carrot opposite to the end which was cut by the blade 36. The blades 42 are all driven by the same motor 43, and all rotate at the same speed.

In this embodiment, there are a series of spaced blades 42, so that the carrot can at this point be cut into individual segments, each having a length equal to the distance between the blades 42. The individual lengths 60 will then drop out through a chute 44.

Depending on the speed of rotation imparted by the motor 24, the carrots in the guides 26 may also be urged outwards by centrifugal force, and the fence 46 extends around the end 40 of the table to ensure that the carrots are not flung out of the guides 26.

FIG. 2 shows the table fully populated with guides. In use carrots 28 will be fed from a hopper through a conveyer which aligns the carrots with the longitudinal extent of the guides, and the carrots will drop into the guides 26 (neither the hopper or the conveyor are shown in the figures). It is quite acceptable for there to be more than one carrot in each guide, but the relative speeds of the conveyer and of the chain should be such that only up to three carrots are received in each guide.

It will be seen from FIGS. 4 and 5 that the guides 26 are formed with six slots 50 in their upward facing surfaces. These slots are present to allow the carrots to be cut into segments, each the length between the slots 50. The blades 42 then are aligned with and pass through the slots to completely sever each carrot into separated segments. Each guide may be made up of individual moulded plastics pieces 52 mounted in line on a common base 54. The bases 54 are designed to slide on the bearers 32. At one end, each guide has a bracket 30 by means of which it can be mounted on the chain 22.

1. A machine for tipping and tailing elongate products, the machine comprising a continuous belt running around a track, the track lying in a plane which is inclined to the horizontal, the belt carrying elongate product guides attached to the belt and each arranged with their long axes extending radially relative to the belt and lying in the plane of the track, means for driving the belt in rotation around the track, a first blade arranged at the lower end of an upper run of the belt, and a second blade arranged at the lower end of a lower run of the belt.

2. A machine as claimed in claim 1, wherein the track is oval with the belt running around two pulleys, the pulleys also lying in the plane of the track.

3. A machine as claimed in claim 1, wherein the belt is in the form of a chain which can be engaged with drive sprockets.

4. A machine as claimed in claim 1, wherein the plane of the track is at between 40° and 50° to the horizontal.

5. A machine as claimed in claim 1, wherein the blades are continuously rotating cut-off discs.

6. A machine as claimed in claim 1, wherein the track includes low-friction bearers and the product guides slide on those bearers as the guides move around the track.

7. A machine as claimed in claim 1, wherein the product guides are arranged side by side along the whole length of the belt.

8. A machine as claimed in claim 1, wherein a plurality of second blades arranged at the lower end of the lower run of the belt, all the blades being parallel to one another and being spaced apart by a distance equal to the desired dimension into which the product is to be cut.

9. A machine as claimed in claim 8, where the product guides are provided with slots aligned with the positions of the blades.

10. A machine as claimed in claim 1, wherein fences are provided at the lower ends of the product guides at those places where the guides will, in use, contain products.

11. A carrot cutting machine for tipping and tailing carrots, the machine comprising a continuous belt running around a track, the track lying in a plane which is inclined to the horizontal, the belt carrying elongate carrot guides attached to the belt and each arranged with their long axes extending radially relative to the belt and lying in the plane of the track, means for driving the belt in rotation around the track, a first blade arranged at the lower end of an upper run of the belt, and a second blade arranged at the lower end of a lower run of the belt.

12. A machine as claimed in claim 11, wherein the track is oval with the belt running around two pulleys, the pulleys also lying in the plane of the track.

13. A machine as claimed in claim 11, wherein the belt is in the form of a chain which can be engaged with drive sprockets.

14. A machine as claimed in claim 11, wherein the plane of the track is at between 40° and 50° to the horizontal.

15. A machine as claimed in claim 11, wherein the blades are continuously rotating cut-off discs.

16. A machine as claimed in claim 11, wherein the track includes low-friction bearers and the carrot guides slide on those bearers as the guides move around the track.

17. A machine as claimed in claim 11, wherein the carrot guides are arranged side by side along the whole length of the belt.

18. A machine as claimed in claim 11, wherein a plurality of second blades arranged at the lower end of the lower run of the belt, all the blades being parallel to one another and being spaced apart by a distance equal to the desired dimension into which the product is to be cut.

19. A machine as claimed in claim 18, where the carrot guides are provided with slots aligned with the positions of the blades.

20. A machine as claimed in claim 11, wherein fences are provided at the lower ends of the carrot guides at those places where the guides will, in use, contain carrots.
